(19) United States
(12) Patent Application Publication
(10) Pub. No.: US 2014/0361560 A1
(43) Pub. Date: Dec. 11, 2014

(54) VEHICLE BODY FRONT STRUCTURE

(71) Applicant: Toyota Jidosha Kabushiki Kaisha, Toyota-shi Aichi-ken (JP)

(72) Inventors: Kosuke Sakakibara, Toyota-shi Aichi-ken (JP); Masanobu Omi, Kasugai-shi Aichi-ken (JP); Akihiro Tamaoki, Tajimi-shi Gifu-ken (JP); Tomoyuki Kuriyama, Toyota-shi Aichi-ken (JP)

(73) Assignee: TOYOTA JIDOSHA KABUSHIKI KAISHA, Toyota-shi Aichi-ken (JP)

(21) Appl. No.: 14/288,906

(22) Filed: May 28, 2014

(30) Foreign Application Priority Data
Jun. 5, 2013 (JP) 2013-119313

(51) Int. Cl. B60R 19/34

(52) U.S. Cl. CPC B60R 19/34
USPC 293/133

(57) ABSTRACT

In a vehicle body front structure, a crush box axially compression-deforms and a bumper extending portion of a bumper reinforcement bends toward a vehicle body rear side when an impact load is input to the bumper extending portion from a vehicle body front side. As a result, a rear end of the bumper extending portion abuts against a front surface of a gusset. This gusset is provided protruding toward a vehicle body width direction outside from a front end portion of a main body portion of a front side member, so the impact load on the bumper extending portion is able to be nicely transmitted to the main body portion via the gusset.

### INCORPORATION BY REFERENCE

The disclosure of Japanese Patent Application No. 2013-119313 filed on Jun. 5, 2013 including the specification, drawings and abstract is incorporated herein by reference in its entirety.

### BACKGROUND OF THE INVENTION

1. Field of the Invention

The invention relates to a vehicle body front structure.

2. Description of Related Art

Japanese Patent Application Publication No. 2012-228907 (JP 2012-228907 A) describes a vehicle body front structure of a vehicle, in which a first protruding portion is provided on a side frame in a manner extending toward a vehicle width direction outside from a side portion of the side frame. Also, a bumper beam extended portion is provided on a bumper beam in a manner extending toward the vehicle width direction outside from both left and right side portions of the bumper beam. The bumper beam extended portion has a second protruding portion that extends rearward with respect to the vehicle body toward the first protruding portion of the side frame.

With a vehicle body front structure such as that described above, when a portion of a front portion of a vehicle body that is to the vehicle body width direction outside of the side frame collides head-on in a frontal collision with a colliding object such as another vehicle (i.e., when a so-called short overlap collision occurs), the second protruding portion is able to abut against the first protruding portion of the side frame by the bumper beam extended portion moving back due to the impact load. As a result, the impact load to the bumper beam extended portion is able to be efficiently transmitted to the side frame via the second protruding portion and the first protruding portion, so the side frame effectively deforms, thus enabling the impact energy to be absorbed.

However, with a vehicle body front structure such as that described above, the second protruding portion is provided on the bumper beam extended portion (hereinafter, referred to as the “bumper extending portion”), so space is required to arrange the second protruding portion. Therefore, there is room for improvement from the viewpoint of saving space.

### SUMMARY OF THE INVENTION

The invention thus provides a vehicle body front structure capable of both nicely transmitting an impact load on a bumper extending portion to a front side member, and saving space.

One aspect of the invention relates to a vehicle body front structure that includes a front side member arranged such that a length direction of the front side member is in coincidence with a vehicle body front-rearward direction, the front side member being arranged on a side portion of a vehicle body front portion; a protruding member that is provided protruding toward a vehicle body width direction outside from a front portion of the front side member; a bumper reinforcement arranged such that a length direction of the bumper reinforcement is in coincidence with the vehicle body width direction, the bumper reinforcement being arranged on the vehicle body front portion, the bumper reinforcement being fixed to a front end of the front side member, and the bumper reinforcement including a bumper extending portion, the bumper extending portion extending to the vehicle body width direction outside of the front side member, the bumper extending portion bending toward a vehicle body rear side and engaging with the protruding member when an impact load is input to the bumper extending portion from a vehicle body front side.

When an impact load is input to the bumper extending portion of the bumper reinforcement from the vehicle body front side, the bumper extending portion bends toward the vehicle body rear side and engages with the protruding member. This protruding member is provided protruding toward the vehicle body width direction outside from the front portion of the front side member, so the impact load on the bumper extending portion is able to be nicely transmitted to the front side member via the protruding member. In this way, the bumper extending portion is configured to bend toward the vehicle body rear side and engage with the protruding member, so a structure such as the second protruding portion described in the related art section is not necessary. As a result, space is able to be saved. Moreover, force in the lateral direction away from the colliding object is able to act on the vehicle body due to sliding contact between the vehicle body width direction outside surface of the bumper extending portion that has bent toward the vehicle body rear side, and the colliding object (such as another vehicle). As a result, the impact load input to the vehicle body from the colliding object is able to be effectively reduced.

In the vehicle body front structure described above, a high rigidity portion may be provided on the bumper extending portion, and the high rigidity portion may be configured to have at least a higher rigidity with respect to a compression load in an extending direction of the bumper extending portion than another portion of the bumper reinforcement.

When the bumper extending portion bends due to receiving an impact load from the vehicle body front side, the extending direction of the bumper extending portion becomes along the input direction of the impact load. The high rigidity portion configured to have at least a higher rigidity with respect to a compression load in the extending direction than another portion of the bumper reinforcement is provided on this bumper extending portion. Therefore, the transmission efficiency of the impact load to the front side member via the bumper extending portion is able to be improved.

In the vehicle body front structure described above, a weak portion may be provided on a base end side of the bumper extending portion.

When an impact load is input to the bumper extending portion of the bumper reinforcement from the vehicle front side, the bumper extending portion is able to bend as set at the weak portion on the base end side, so the bumper extending portion is able to nicely rotate toward the vehicle body rear side around the weak portion.

In this vehicle body front structure, the weak portion may be provided on a rear surface side of the bumper extending portion.

When the bumper extending portion bends due to an impact load from the vehicle body front side, the compression load is able to act on the weak portion. As a result, the bumper reinforcement is able to be prevented from inadvertently breaking from the tensile load on the weak portion.

In the vehicle body front structure described above, a low rigidity portion having a lower rigidity than a main body portion of the front side member may be provided on the front portion of the front side member; and the bumper reinforcement may be fixed to a front end of the low rigidity portion, and the protruding member may be provided on a front end portion of the main body portion of the front side member, and the bumper extending portion may engage with the protruding member by the low rigidity portion deforming and the bumper extending portion bending toward a vehicle body rear side from the impact load.

The low rigidity portion is provided on the front portion of the front side member, and the bumper reinforcement is fixed to the front end of the low rigidity portion, so if a frontal collision of the vehicle occurs, the impact is able to be absorbed by the low rigidity portion deforming. Also, the low rigidity portion will deform from the impact load even when the bumper extending portion bends toward the vehicle body rear side due to an impact load from the vehicle body front side. As a result, the bumper extending portion engages with the protruding member of the front side member, so deformation of the low rigidity portion will not be impeded by the bumper extending portion engaging with the protruding portion.

Another aspect of the invention relates to a vehicle body front structure that includes a front side member having a low rigidity portion provided on a front end portion of a main body portion of the front side member, the front side member arranged such that a length direction of the front side member is in coincidence with a vehicle body front-rearward direction, the front side member being arranged on a side portion of a vehicle body front portion, the low rigidity portion having a lower rigidity than the main body portion of the front side member; a bumper reinforcement arranged such that a length direction of the bumper reinforcement is in coincidence with a vehicle body width direction, the bumper reinforcement being arranged on the vehicle body front portion, the bumper reinforcement being fixed to a front end of the low rigidity portion and the bumper reinforcement including a bumper extending portion, the bumper extending portion extending to a vehicle body width direction outside of the front side member, a high rigidity portion provided on the bumper extending portion having a higher rigidity than another portion of the bumper reinforcement; and a protruding member that is provided protruding toward the vehicle body width direction outside from the front end portion of the main body portion, the bumper extending portion abutting against the protruding member when an impact load is input to the bumper extending portion side of the bumper reinforcement from a vehicle body front side.

According to this aspect, when an impact load is input to the bumper extending portion of the bumper reinforcement from the vehicle body front side, the low rigidity portion provided on the front end portion of the front side member deforms and the bumper extending portion abuts against the protruding portion. The high rigidity portion having a higher rigidity than another portion of the bumper reinforcement is provided on this bumper extending portion. Also, the protruding member is provided protruding toward the vehicle body width direction outside from the front end portion of the front side member. As a result, an impact load input to the bumper extending portion is able to be nicely transmitted to the front side member via the protruding member. Also, the bumper extending portion directly abuts against the protruding member in this way, so a structure such as the second protruding portion described in the related art section is not necessary. As a result, space is able to be saved.

As described above, the vehicle body front structure according to the aspects of the invention is capable of both nicely transmitting an impact load on a bumper extending portion to a front side member, and saving space.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a plan view of part of the structure of a vehicle body front structure according to a first example embodiment of the invention;

FIG. 2 is a plan view of a state in which a bumper extending portion is abutting against a protruding member in the vehicle body front structure;

FIG. 3 is a plan view of a state in which a front side member is bent by an impact load from the protruding member in the vehicle body front structure;

FIG. 4 is a plan view of part of the structure of a vehicle body front structure according to a second example embodiment of the invention;

FIG. 5A is a plan view of part of the structure of a vehicle body front structure according to a third example embodiment of the invention;

FIG. 5B is a plan view of a state in which a bumper extending portion is abutting against a protruding member in the vehicle body front structure according to the third example embodiment of the invention;

FIG. 6A is a plan view of part of the structure of a vehicle body front structure according to a fourth example embodiment of the invention; and

FIG. 6B is a plan view of a state in which a bumper extending portion is abutting against a protruding member in the vehicle body front structure according to the fourth example embodiment of the invention.

### DETAILED DESCRIPTION OF EMBODIMENTS

### First Example Embodiment

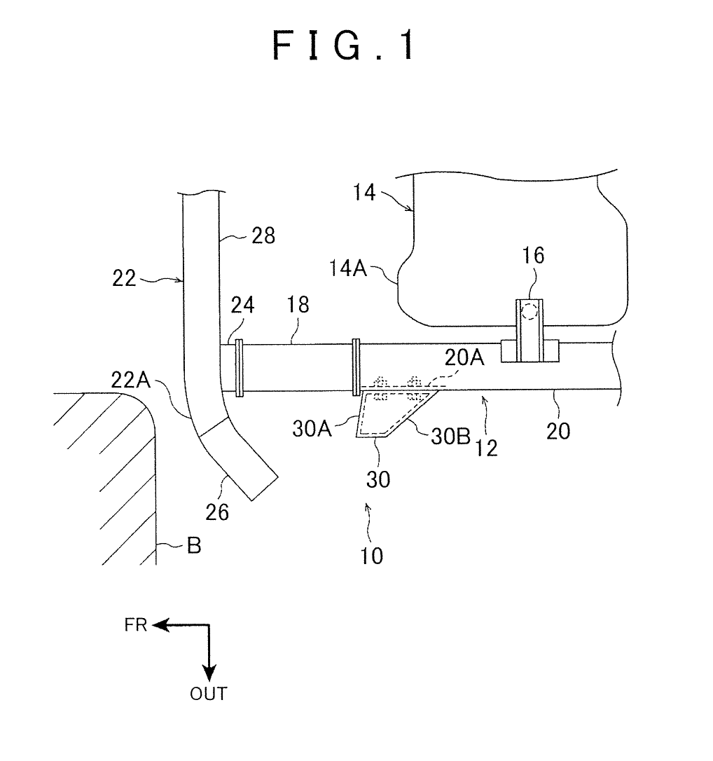

A vehicle body front structure 10 according to a first example embodiment of the invention will now be described with reference to FIGS. 1 to 3. In the drawings, arrow FR indicates a forward direction (advancing direction) with respect to the vehicle, arrow UP indicates an upward direction with respect to the vehicle, and arrow OUT indicates an outside in a vehicle width direction. Hereinafter, when front-rear (longitudinal) directions and up-down (vertical) directions are used in the description, they indicate the front and rear in a vehicle longitudinal direction, and up and down in a vehicle vertical direction.

(Structure)

The vehicle body front structure 10 shown in FIG. 1 is applied to a vehicle body of a sedan type vehicle (automobile), for example, and includes a pair of left and right front side members 12. The left and right front side members 12 are frame members of the vehicle body that are each formed in a rectangular closed sectional shape when viewed from the vehicle body front-rearward direction, and are arranged with the vehicle body front-rearward direction as the length direction, on body side portions of a vehicle body front portion. The vehicle body front structure 10 is formed bilaterally symmetrical. In FIGS. 1 to 3, the right side of the vehicle body is omitted.

A power unit 14 is arranged between the left and right front side members 12. In this example embodiment, this power unit 14 includes an engine and a transmission, and is supported by the left and right front side members 12 via an engine mount 16. Although not shown in the drawing, a front wheel of the vehicle is arranged on the opposite side of each of the left and right front side members 12 from the power unit 14.

A crush box 18 as a low rigidity portion is arranged on a front portion of the left and right front side members 12. This crush box 18 is formed separate from a main body portion 20 of the front side member 12, and is fixed to a front end of the main body portion 20 by means such as bolt fastening.

The left and right crush boxes 18 are each formed in a rectangular closed sectional shape when viewed from the vehicle body front-rearward direction, for example, and have a rigidity (bearing capacity) with respect to an axial compression load in the vehicle body front-rearward direction that is lower than that of the main body portion 20. These crush boxes 18 are configured to absorb the energy by deforming before the main body portion 20 deforms, when the vehicle is involved in a head-on collision.

A bumper reinforcement 22 arranged with the vehicle body front-rearward direction as the length direction on the vehicle body front portion, is fixed by means such as bolt fastening to a front end of the left and right crush boxes 18. A fixing portion 24 for fixing the crush boxes 18 is provided protruding toward the vehicle body rear side, on a rear surface of the bumper reinforcement 22.

This bumper reinforcement 22 is a so-called B-type cross-section type in which a sectional shape when'viewed form the vehicle width direction is formed in a general B-shape, for example. This bumper reinforcement 22 has left and right bumper extending portions 22A that protrude toward the vehicle body width direction outside of the left and right crush boxes 18. The left and right bumper extending portions 22A are gently curved toward the vehicle body rear side as they head toward the vehicle body width direction outside. Although not shown, an absorber (cushioning material) made of foam or the like is attached to a front end surface of the bumper reinforcement 22, and the absorber and the bumper reinforcement 22 are covered by a bumper cover.

A high rigidity portion 26 is provided on both of the left and right bumper extending portions 22A. Each high rigidity portion 26 is formed by material that is harder than the material that forms another portion of the bumper reinforcement 22 (i.e., a portion other than the high rigidity portion 26; hereinafter referred to as a “bumper intermediate portion 28”), and is fixed to the bumper intermediate portion 28 by means such as bolt fastening, for example. This high rigidity portion 26 has a higher rigidity than the bumper intermediate portion 28 does.

In this example embodiment, a tip end portion and an intermediate portion of the bumper extending portion 22A in the extending direction are the high rigidity portion 26, and the high rigidity portion 26 is not provided on a base end portion (i.e., a portion on the fixing portion 24 side) of the bumper extending portion 22A. However, the embodiment of the invention is not limited to this. That is, the entire bumper extending portion 22A may be the high rigidity portion 26. Also, the high rigidity portion 26 need only have at least a higher rigidity with respect to a compression load in the extending direction of the bumper extending portion 22A than the bumper intermediate portion 28 does, and may be integrally formed by the same material as that of the bumper intermediate portion 28. In this case, for example, a horizontal bead along the extending direction (the length direction) of the bumper extending portion 22A may be formed on the bumper extending portion 22A, and the portion reinforced by this horizontal bead may be a high rigidity portion. Also, for example, a portion where a reinforced member such as a patch is attached on the bumper extending portion 22A may be a high rigidity portion.

Meanwhile, a gusset 30 as a protruding portion is attached to a front end portion of the main body portion 20 on a vehicle body rear side of the bumper extending portion 22A. This gusset 30 is formed in a hollow block-shape by metal material, for example, and protrudes toward the vehicle body width direction outside from an outside wall 20A that is a wall on the vehicle body width direction outside of the main body portion 20. This gusset 30 is fastened and fixed to the outside wall 20A by a fastener such as a nut and bolt, for example. The material of the gusset 30 is not limited to metal, and may also be resin, for example. Also, the fixing method for fixing the gusset 30 to the front side member 12 is not limited to fastening. Any of various methods, such as welding, adhesion, and riveting or the like, for example, may be used. Also, the gusset 30 may be integrally formed with the front side member 12.

This gusset 30 is formed in a trapezoidal shape in a plan view, and a front surface 30A and a rear surface 30B are inclined toward the vehicle body rear side as they head the vehicle body width direction inside. The rear surface 30B is set to have a larger inclination angle with respect to the vehicle body width direction than the front surface 30A does. Also, a vehicle width direction inside end portion (i.e., a rear end portion) of the rear surface 30B is positioned to a vehicle body rear side of a vehicle body front side end portion 14A of the power unit 14, and to a vehicle body front side of a generally center portion (i.e., the engine mount 16) in the vehicle body front-rearward direction of the power unit 14, in a plan view.

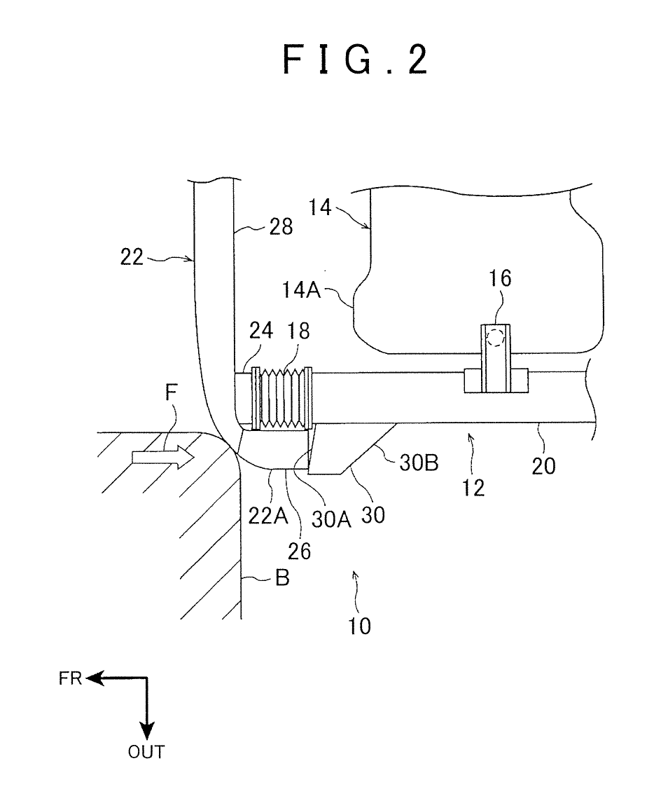

Here, in this example embodiment, the crush box 18 axially compression-deforms in the vehicle body front-rearward direction by an impact load F from the vehicle body front side, as shown in FIG. 2, when a portion of the front portion of the vehicle body that is to the vehicle body width direction outside of the front side member 12 collides head-on in a head-on collision with a colliding object (here, a barrier B) such as another vehicle (in a so-called short overlap collision). Also at this time, the bumper extending portion 22A of the bumper reinforcement 22 bends at the base end side by the impact load F, and assumes a position in which it extends toward the vehicle body rear side (i.e., the bumper extending portion 22A bends so as to follow the vehicle body front-rearward direction). As a result, a rear end of the bumper extending portion 22A abuts against the front surface 30A of the gusset from the vehicle body front side (i.e., engages so as to be able to transmit the collision load F).

That is, in this example embodiment, the tip end of the bumper extending portion 22A comes closer to the gusset 30 by the crush box 18 axially compression-deforming. Also, the tip end (rear end) of the bumper extending portion 22A comes even closer to the gusset 30 by the bumper extending portions 22A bending toward the vehicle body rear side. As a result, the length dimension of the bumper extending portion 22A and the arrangement position of the gusset 30 are set such that the tip end (rear end) of the bumper extending portion 22A abuts against the front surface 30A of the gusset 30.

The crush box 18 is set to have a lower bearing capacity with respect to the impact load F than the bumper reinforcement 22 does, so normally it (i.e., the crush box 18) will deform before the bumper extending portion 22A does. Also, depending on the manner of the collision, there may also be cases in which the crush box 18 buckles without axially compression-deforming, but in this example embodiment, deformation of the crush box 18 is not impeded by the bumper extending portion 22A abutting against the gusset 30.

(Operation and Effect)

Next, the operation and effects of the first example embodiment will be described.

With the vehicle body front structure 10 having the structure described above, when the impact load F is input to the bumper extending portion 22A of the bumper reinforcement 22 from the vehicle body front side, the bumper extending portion 22A bends toward the vehicle body rear side, and the rear end of the bumper extending portion 22A abuts against the front surface 30A of the gusset 30. This gusset 30 is provided protruding toward the vehicle body width direction outside from the front end portion of the main body portion 20 of the front side members 12, so the impact load F on the bumper extending portion 22A is able to be nicely transmitted to the front side member 12 via the gusset 30. In this way, the bumper extending portion 22A will bend toward the vehicle body rear side and abut against the gusset 30, so a structure such as the second protruding portion described in the related art section is not necessary. As a result, space is able to be saved, and the structure is able to be simplified.

Moreover, force in the lateral direction (i.e., the vehicle body width direction) away from the barrier B is able to act on the vehicle body due to direct or indirect sliding contact between the vehicle body width direction outside surface of the bumper extending portion 22A that has bent toward the vehicle body rear side, and the barrier B. As a result, the impact load F input to the vehicle body from the barrier B is able to be effectively reduced, and deformation of a vehicle cabin is able to be significantly inhibited.

Also, in this example embodiment, the high rigidity portion 26 that has a higher rigidity than the other portion of the bumper reinforcement 22 does is provided on the bumper extending portion 22A, so the transmission efficiency of the impact load F to the front side member 12 via the bumper extending portion 22A is able to be improved.

Furthermore, the high rigidity portion 26 is not provided on the base end side of the bumper extending portion 22A, so when the impact load F is input to the bumper extending portion 22A, the bumper extending portion 22A is able to bend nicely at the base end side.

Also, in this example embodiment, when the bumper extending portion 22A bends toward the vehicle body rear side due to the impact load F from the vehicle body front side, the crush box 18 will deform (crush) in the vehicle body front-rearward direction. Thus, because the length dimension of the bumper extending portion 22A and the arrangement position of the gusset 30 are set such that the bumper extending portion 22A will abut against the gusset 30, deformation of the crush box 18 will not be impeded by the bumper extending portion 22A abutting against the gusset 30.

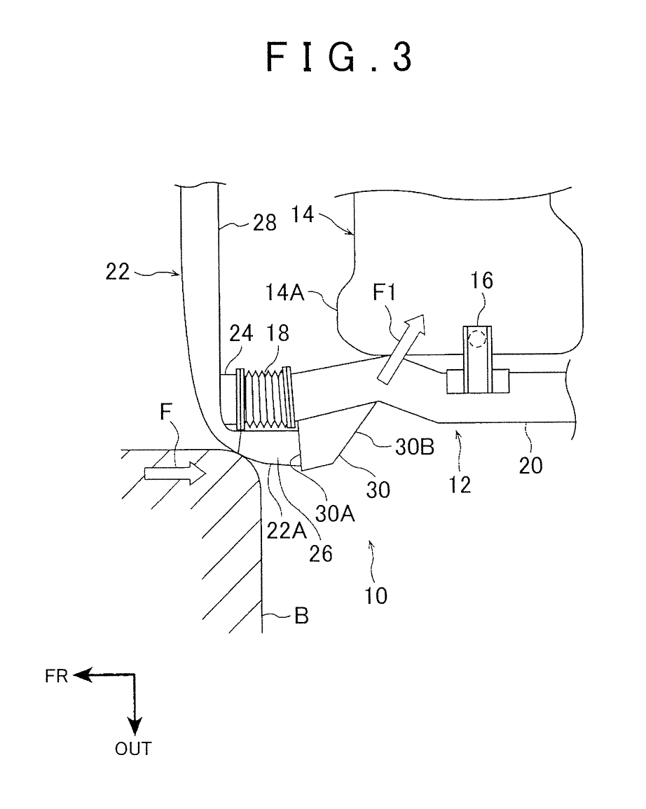

Also, in this example embodiment, the gusset 30 is provided protruding toward the vehicle body width direction outside from the front end portion of the main body portion 20 of the front side member 12, so when the impact load F from the vehicle body front side is input to the gusset 30, a bending moment will act on the main body portion 20. As a result, the main body portion 20 is able to bend toward the vehicle body width direction inside and abut against the power unit 14, as shown in FIG. 3, so the impact load F can be dispersed to side of the vehicle body, which is opposite to a collision side, via the power unit 14 (see arrow F1 in FIG. 3).

Moreover, the rear surface 30B of the gusset 30 that is fixed to the front end portion of the main body portion 20 is inclined toward the vehicle body rear side as they head toward the vehicle body width direction inside, so the gusset 30 is able to be inhibited from becoming larger even if the rear end of the gusset 30, which is where the front side member 12 starts to bend, is arranged to the side of the power unit 14.

Further, with this example embodiment, the front surface 30A of the gusset 30 is inclined toward the vehicle body rear side as they head toward the vehicle body width direction inside, so when the rear end of the bumper extending portion 22A is abutted against the front surface 30A of the gusset 30, the front surface 30A of the gusset 30 interferes with the rear end of the bumper extending portion 22A, so these two will not inadvertently come out of abutment with each other.

Next, another example embodiment of the invention will be described. Structure and operation that is basically the same as that in the first example embodiment described above will be denoted by the same reference characters used in the first example embodiment, and descriptions thereof will be omitted.

### Second Example Embodiment

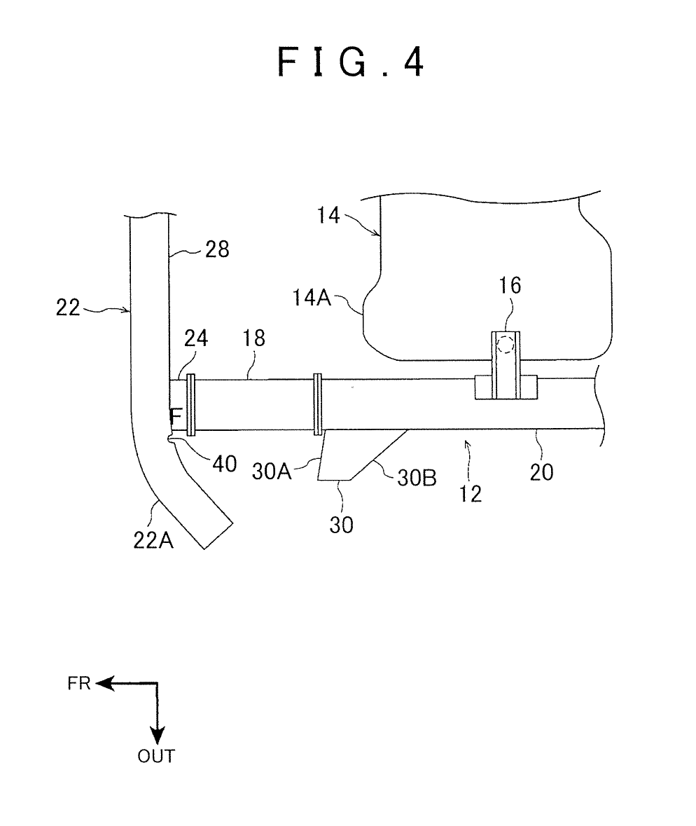

FIG. 4 is a plan view of a vehicle body front structure according to a second example embodiment of the invention. This example embodiment has basically the same structure as the first example embodiment, but in this example embodiment, the high rigidity portion 26 is not provided on the bumper extending portion 22A of the bumper reinforcement 22. Also, a weak portion 40 is provided on the rear surface of the base end portion of the bumper extending portion 22A.

In this example embodiment, the weak portion 40 is formed by a longitudinal bead that extends in the vehicle body vertical direction, but the embodiment of the invention is not limited to this. That is, the structure of the weak portion 40 may also be modified as appropriate. For example, the weak portion may also be formed by a notched portion or a thin portion.

In this example embodiment, structure other than that described above is the same as it is in the first example embodiment. Therefore, operation and effects that are basically the same as those of the first example embodiment described above are displayed. Moreover, in this example embodiment, when the impact load F is input to the bumper extending portion 22A from the vehicle front side, the bumper extending portion 22A is able to bend as set at the weak portion 40 of the base end portion, so the bumper extending portion 22A is able to nicely rotate toward the vehicle body rear side around the weak portion 40.

Also, in this example embodiment, the weak portion 40 is provided on the rear surface side of the bumper extending portion 22A, so when the bumper extending portion 22A bends by the impact load F from the, vehicle body front side, a compression load is able to be act on the weak portion 40. As a result, the bumper reinforcement 22 is able to be prevented from inadvertently breaking from a tensile load on the weak portion 40.

### Third Example Embodiment

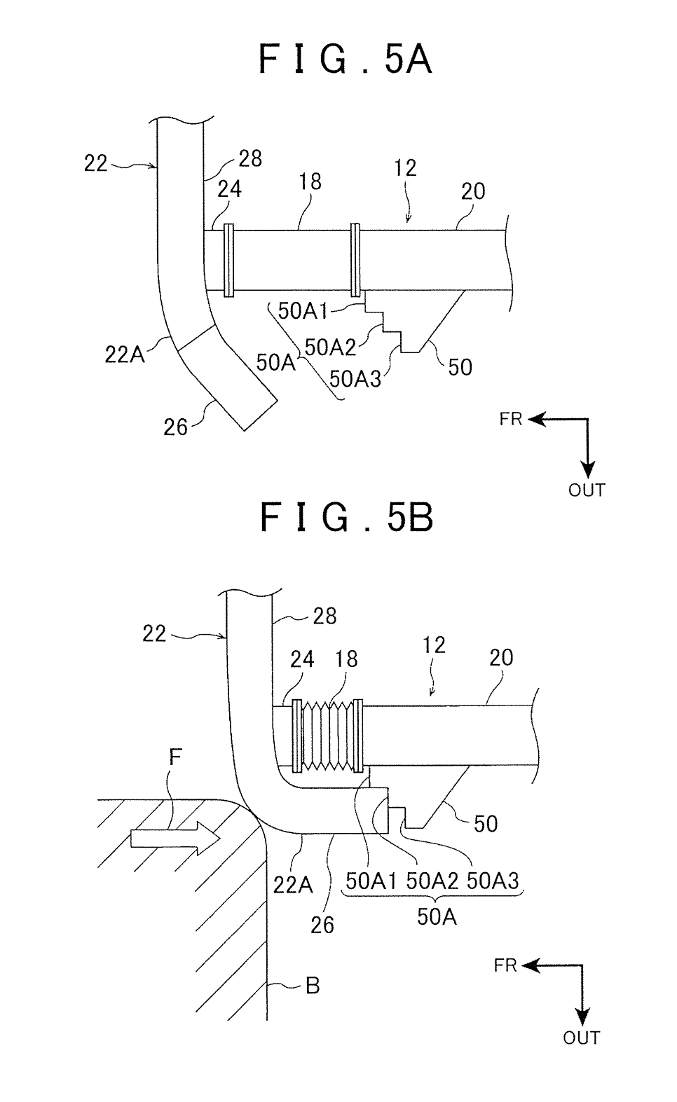

FIG. 5A is a plan view of a vehicle body front structure according to a third example embodiment of the invention. This example embodiment has basically the same structure as the first example embodiment described above, but in this example embodiment, the structure of a gusset 50 as a protruding member differs from that of the gusset 30 according to the first example embodiment described above. This gusset 50 has a front surface 50A that is formed in a stepped shape when viewed from above. This stepped-shaped front surface 50A is formed with three steps here, and is formed retreating toward the vehicle body rear side as they head toward the vehicle body width direction outside. More specifically, a vehicle body width direction intermediate portion 50A2 of the front surface 50A is positioned to the vehicle body rear side of a vehicle body width direction inside portion 50A1 of the front surface 50A, and a vehicle body width direction outside portion 50A3 of the front surface 50A is positioned to the vehicle body rear side of the vehicle body width direction intermediate portion 50A2.

Also, in this example embodiment, the positions of the vehicle body width direction inside portion 50A1, the vehicle body width direction intermediate portion 50A2, and the vehicle body width direction outside portion 50A3 with respect to the vehicle body are set as described below. That is, when the bumper extending portion 22A is bent toward the vehicle body rear side after the crush box 18 completely axially compression-deforms from the impact load F, the rear end of the bumper extending portion 22A abuts against the vehicle body width direction outside portion 50A3 of the front surface 50A of the gusset 50. On the other hand, when the bumper extending portion 22A is bent toward the vehicle body rear side before the crush box 18 completely axially compression-deforms, i.e., while an uncrushed portion of the crush box 18 remains, the rear end of the bumper extending portion 22A abuts against the vehicle body width direction intermediate portion 50A2 or the vehicle body width direction inside portion 50A1 of the front surface 50A of the gusset 50 (FIG. 5B is a view of a state in which a rear end portion of the bumper extending portion 22A is abutted against the vehicle body width direction intermediate portion 50A2). Because of this kind of structure, the impact load F to the bumper extending portion 22A is able to be nicely transmitted to the front side member 12 via the gusset 50, even with an impact in which an uncrushed portion of the crush box 18 remains (i.e., in which the crush box 18 has not been completely crushed).

### Fourth Example Embodiment

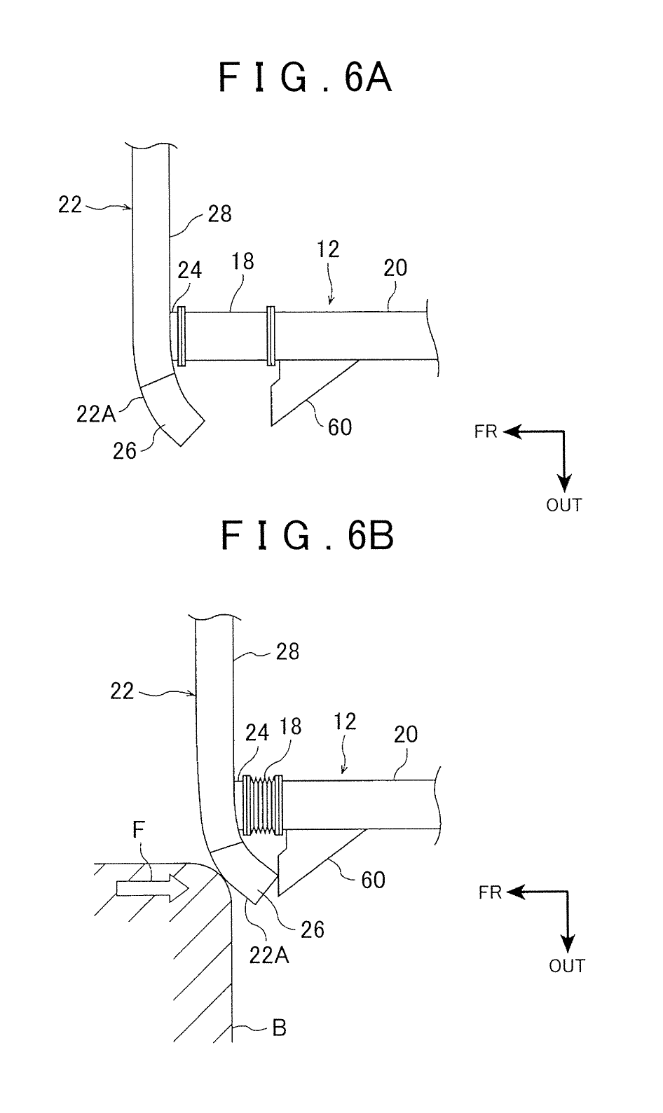

FIG. 6A is a plan view of a vehicle body front structure according to a fourth example embodiment of the invention. This example embodiment has basically the same structure as the first example embodiment described above. However, in this example embodiment, a gusset 60 as a protruding member is formed having a generally triangular shape when viewed from above. Also, in this example embodiment, when the impact load F is input to the bumper extending portion 22A, the crush box 18 will crush in the vehicle body front-rearward direction such that the bumper extending portion 22A abuts against the gusset 60 from the vehicle body front side, as shown in FIG. 6B. That is, the bumper extending portion 22A is configured to abut against the gusset 60 regardless of whether the bumper extending portion 22A bends toward the vehicle body rear side. In this example embodiment as well, a structure such as the second protruding portion described in the related art section is unnecessary, so space is able to be saved.

<Supplemental Description of the Example Embodiments>

In the example embodiments described above, the crush box 18 as a low rigidity portion is fixed to the main body portion 20 of the front side member 12, but the embodiment of the invention is not limited to this. That is, a low rigidity portion (i.e., a weak portion) may also be integrally provided on the front portion of the front side member.

Also, in the second example embodiment described above, the weak portion 40 is provided on the rear surface side of the bumper extending portion 22A, but the embodiment of the invention is not limited to this. That is, a weak portion may also be provided on the fro& surface side of the bumper extending portion.

Also, in the example embodiments described above, the bumper extending portion 22A abuts against the gussets 30, 50, and 60 as protruding portions from the vehicle body front side, but the embodiment of the invention is not limited to this. That is, a bumper extending portion may also abut against the protruding member from the vehicle body width direction outside. However, the bumper extending portion must engage with the protruding member is such a way that enables an impact load to be transmitted (for example, the bumper extending portion may be engaged with the protruding member in the vehicle body width direction). Also, the shape of the protruding member is not limited to the shapes of the gussets 30, 50, and 60 in the example embodiments, and may be modified as appropriate.

In addition, the invention may be modified without departing from the scope thereof. Also, the scope of the embodiment of the invention is not limited by the example embodiments described above.

What is claimed is:

1. A vehicle body front structure comprising:
a front side member arranged such that a length direction of the front side member is in coincidence with a vehicle body front-rearward direction, the front side member being arranged on a side portion of a vehicle body front portion;
a protruding member that is provided protruding toward a vehicle body width direction outside from a front portion of the front side member;
a bumper reinforcement arranged such that a length direction of the bumper reinforcement is in coincidence with the vehicle body width direction, the bumper reinforcement being arranged on the vehicle body front portion, the bumper reinforcement being fixed to a front end of the front side member, and the bumper reinforcement including a bumper extending portion, the bumper extending portion extending to the vehicle body width direction outside of the front side member, the bumper extending portion bending toward a vehicle body rear side and engaging with the protruding member when an impact load is input to the bumper extending portion from a vehicle body front side.

2. The vehicle body front structure according to claim 1, wherein
a high rigidity portion is provided on the bumper extending portion, and the high rigidity portion is configured to have at least a higher rigidity with respect to a compression load in an extending direction of the bumper extending portion than another portion of the bumper reinforcement.

3. The vehicle body front structure according to claim 1, wherein
a weak portion is provided on a base end side of the bumper extending portion.

4. The vehicle body front structure according to claim 3, wherein
the weak portion is provided on a rear surface side of the bumper extending portion.

5. The vehicle body front structure according to claim 1, wherein
a low rigidity portion having a lower rigidity than a main body portion of the front side member is provided on the front portion of the front side member; and
the bumper reinforcement is fixed to a front end of the low rigidity portion, and the protruding member is provided on a front end portion of the main body portion of the front side member, and the bumper extending portion engages with the protruding member by the low rigidity portion deforming and the bumper extending portion bending toward a vehicle body rear side from the impact load.

6. A vehicle body front structure comprising:
a front side member having a low rigidity portion provided on a front end portion of a main body portion of the front side member, the front side member arranged such that a length direction of the front side member is in coincidence with a vehicle body front-rearward direction, the front side member being arranged on a side portion of a vehicle body front portion, the low rigidity portion having a lower rigidity than the main body portion of the front side member;
a bumper reinforcement arranged such that a length direction of the bumper reinforcement is in coincidence with a vehicle body width direction, the bumper reinforcement being arranged on the vehicle body front portion, the bumper reinforcement being fixed to a front end of the low rigidity portion, and the bumper reinforcement including a bumper extending portion, the bumper extending portion extending to a vehicle body width direction outside of the front side member, a high rigidity portion provided on the bumper extending portion having a higher rigidity than another portion of the bumper reinforcement; and
a protruding member that is provided protruding toward the vehicle body width direction outside from the front end portion of the main body portion, the bumper extending portion abutting against the protruding member when an impact load is input to the bumper extending portion side of the bumper reinforcement from a vehicle body front side.
